(19) United States
(12) Patent Application Publication
(10) Pub. No.: US 2024/0181462 A1
(43) Pub. Date: Jun. 6, 2024

(54) PCR PLATE SEALING FILM WITH GOOD SEALING EFFECT

(71) Applicant: Meidong Huicheng Life Technology (Kunshan) Co., Ltd., Suzhou, Jiangsu (CN)

(72) Inventors: BO TANG, Suzhou, Jiangsu (CN); ZIXIAN LIU, Suzhou, Jiangsu (CN); GANG LIU, Suzhou, Jiangsu (CN); ZIDE LIU, Suzhou, Jiangsu (CN); YIYONG YUAN, Suzhou, Jiangsu (CN); HUA ZHAO, Suzhou, Jiangsu (CN)

(21) Appl. No.: 17/795,850

(22) PCT Filed: Nov. 9, 2021
(86) PCT No.: PCT/CN2021/129616

§ 371 Date: Jul. 27, 2022

(30) Foreign Application Priority Data
Oct. 20, 2021 (CN) 202111224193.5

(51) Int. Cl. B01L 9/00

(52) U.S. Cl. CPC B01L 9/52; B01L 2200/021; B01L 2200/0689; B01L 2300/045

(57) ABSTRACT

The present disclosure provides a PCR plate sealing film with good sealing effect, and relates to the technical field of experimental supplies, wherein the PCR plate sealing film comprises a supporting main plate and soft sealing films; L-shaped expansion rods are fixedly mounted on one end surface of the supporting main plate respectively; lateral-position limiting bars are fixedly mounted at lower ends of the two L-shaped expansion rods; a plurality of sealing bulges are integrally arranged on lower surfaces of the soft sealing films respectively; and the soft sealing films are located below the supporting main plate. The PCR plate sealing film provided by the present disclosure is fixed by a fixing component, to prevent the soft sealing films from moving up and down after being mounted.

### TECHNICAL FIELD

The present disclosure relates to the technical field of experimental supplies, in particular to a PCR plate sealing film with good sealing effect.

### BACKGROUND

PCR plate is mainly used as a carrier of primer, Taq DNA polymerase, dNTP, template nucleic acid, Mg buffer solution or the like in amplification in the polymerase chain reaction. When the PCR plate is used, the top of the PCR plate needs to be sealed to protect objects inside the PCR plate. For example, a 96-well plate sealing film proposed in a patent with the application number of CN201921253011.5 comprises a waterproof layer, a substrate layer, an anti-evaporation layer and an adhesive layer, which are sequentially arranged; a first adhesive layer is arranged between the waterproof layer and the substrate layer; a second adhesive layer is arranged between the substrate layer and the anti-evaporation layer; the waterproof layer, the first adhesive layer, the substrate layer, the second adhesive layer, the anti-evaporation layer and the adhesive layer are integrally pressed; the total thickness of the sealing film is 100-145 μm; the thickness of the waterproof layer is 20-30 μm; the thickness of the first adhesive layer is 5-10 μm; the thickness of the substrate layer is 40-50 μm; the thickness of the second adhesive layer is 5-10 μm; the thickness of the anti-evaporation layer is 20-30 μm; and the thickness of the adhesive layer is 10-15 μm. The above plate sealing film has excellent waterproof and anti-evaporation performance at 120° C., can be removed for many times without curling easily, and has good sealing performance.

However, the above plate sealing film has the following defects in use; after the plate sealing film is used, the PCR plate will move later; the plate sealing film is easy to be separated during movement, so that the objects inside the PCR plate are in contact with the external world to further affect the later experimental effects: the plate sealing film needs to be matched with the PCR plates with different wells according to different use requirements, so the plate sealing films with different sizes will be used for sealing the tops of the PCR plates; and the operation is relatively complicated due to a great number of clearances exist when the plate sealing film is cleaned.

### SUMMARY

### (I) Technical Problems to be Solved

In view of shortcomings of the prior art, the present disclosure provides a PCR plate sealing film with good sealing effect, which solves the problem that the objects inside the PCR plate are in contact with the external world due to the plate sealing film is easy to be separated during movement, the problem that a great number of plate sealing films need to be prepared due to the plate sealing film needs to be matched with the PCR plates with different wells according to different use requirements and the plate sealing films with different sizes will be used for sealing the tops of the PCR plates, and the problem that the operation is relatively complicated due to a great number of clearances exist when the plate sealing film is cleaned.

### (II) Technical Solution

The present disclosure adopts the following technical solutions to achieve the above purpose:
a PCR plate sealing film with good sealing effect comprises a supporting main plate and soft sealing films; L-shaped expansion rods are fixedly mounted on one end surface of the supporting main plate respectively; lateral-position limiting bars are fixedly mounted at lower ends of the two L-shaped expansion rods; a plurality of sealing bulges are integrally arranged on lower surfaces of the soft sealing films respectively; the soft sealing films are located below the supporting main plate; a component turning slot is formed in one side of an upper surface of the supporting main plate; soft film mounting bars are integrally arranged on a lower surface of the supporting main plate at one side away from the component turning slot; a soft sleeve mounting slot is formed in a surface of the soft film mounting bar at one side close to the component turning slot; a mounting component is mounted inside the component turning slot; a lower end of the mounting component passes through a soft film lateral-position clamping slot; a plurality of soft sealing films are mounted between the lower end of the mounting component and the soft sleeve mounting slot; a butt positioning bar is arranged above each soft sealing film; a plurality of butt positioning slots are respectively formed in a lower surface of the supporting main plate; each butt positioning bar is clamped into the corresponding butt positioning slot; and a fixing component is mounted inside one end of the supporting main plate at one side away from the L-shaped expansion rods, and comprises a first expansion slot and a second expansion slot.

Preferably, the mounting component comprises two lateral-position guiding slots, which are respectively formed in both sides of an inner wall of the component turning slot; and a limiting slider is mounted inside the lateral-position guiding slot at one side close to the L-shaped expansion rod in a limited sliding manner.

Preferably, a threaded transmission rod is rotatably mounted inside the lateral-position guiding slot at one side close to the fixing component; a second knob is fixedly mounted at the end of the threaded transmission rod penetrating through the component turning slot; and a threaded sleeve ring is mounted on a rod body of the threaded transmission rod in a threaded manner.

Preferably, the threaded sleeve ring is arranged inside the lateral-position guiding slot at one side close to the L-shaped expansion rod in a limited manner; a component mounting rod is fixedly mounted between the threaded sleeve ring and the limiting slider; and a C-shaped steering bar is rotatably mounted on the rod body of the component mounting rod through a turn-over mounting sleeve.

Preferably, a soft film lateral-position clamping slot is formed in a lower end surface of the C-shaped steering bar at one side away from the soft film mounting bar; a movable inserting slot is formed in an inner upper end of the soft film lateral-position clamping slot; a T-shaped limiting plate is mounted at the inner upper end of the movable inserting slot through a plurality of limiting springs, and is movably arranged in the movable inserting slot; a pressing transverse plate is integrally arranged on the lower end surface of the T-shaped limiting plate; and a plurality of positioning rods are arranged on the lower surface of the pressing transverse plate.

Preferably, the first expansion slot and the second expansion slot are respectively formed in the surface of the supporting main plate at one side away from the L-shaped expansion rod; a second expansion rod is inserted inside the second expansion slot; a limit mounting disk is integrally arranged at the end of the rod body of the second expansion rod located at one side in the second expansion slot; a fine-adjustment spring is fixedly mounted between the limit mounting disk and an inner wall of one side of the second expansion slot; a first expansion rod is inserted inside the second expansion slot; a plurality of matching teeth are integrally arranged at one side of the rod body of the first expansion rod respectively; and the lateral-position limiting bars are fixedly mounted at lower ends of one sides of the first expansion rod and the second expansion rod.

Preferably, a rotating arc slot is formed inside the supporting main plate located at one side between the plurality of matching teeth and the second expansion slot; a transmission gear is rotatably mounted inside the rotating arc slot in a limited manner; and a rotating threaded slot is formed in the supporting main plate located at one side of the middle of the rotating arc slot.

Preferably, the rotating threaded slot is communicated with the rotating arc slot; a matching bolt is mounted inside the rotating threaded slot in a threaded rotating manner; a first knob is fixedly mounted on the upper surface of the matching bolt; the rotating arc slot is communicated with one side of the first expansion slot; and the transmission gear and the corresponding matching teeth are subjected to meshed transmission.

Preferably, a matching through hole is formed in a center of the transmission gear; transmission bulges are integrally arranged at both sides of the rod body of the matching bolts respectively; the transmission bulges are matched with the matching through hole in a limited manner; matching threads are formed on the outer surface of each transmission bulge; and each transmission bulge is matched with the inner wall of the rotating threaded slot through the matching threads in a threaded manner.

Preferably, a plurality of lateral positioning holes are respectively formed in one side of each soft sealing film at one side close to the mounting component in a penetrating manner; an insertion mounting soft sleeve is integrally arranged on one side of each soft sealing film at one side close to the soft sleeve mounting slot respectively; a limit penetrating rod is integrally arranged inside the soft sleeve mounting slot: the outer periphery of the limit penetrating rod is matched with each insertion mounting soft sleeve in an inserting manner; a PCR plate clamping slot is formed in an opposite surface of each lateral-position limiting bar; and each lateral positioning hole is matched with the corresponding positioning rod in an inserting manner.

Compared with the prior art, the present disclosure has the following beneficial effects:

1. The PCR plate sealing film provided by the present disclosure is fixed by the fixing component, to prevent the soft sealing films from moving up and down after being mounted. Compared with the prior art, the present disclosure solves problems that a PCR plate is still movable after the plate sealing film is used, and the plate sealing film is easy to be separated during movement, thereby making objects inside the PCR plate be in contact with the external world to further affect the later experimental effects, so the sealing performance of the present disclosure is greatly improved in comparison with the prior art. When the fixing component is used, the first knob is rotated first, so that the matching bolt rotates inside the rotating arc slot; the matching bolt is matched with the rotating arc slot to effectively avoid moving again after adjustment; the transmission bulges are arranged on the matching bolt and are matched with the matching through holes, so that the transmission gear can rotate accordingly; the matching threads are provided to ensure the normal matching of the matching bolt; the first expansion rod can be adjusted in position by utilizing the rotation of the transmission gear and the meshing with the matching teeth; the second expansion rod is driven to move accordingly by the lateral-position limiting bars; and the first expansion rod is matched with the second expansion slot through the fine-adjustment spring, so that the fixing position can be finely adjusted by the second expansion rod, thereby avoiding the problem that the fixing position is not fixed completely at certain small angles.

2. The width of the soft sealing films can be controlled and adjusted by the mounting component, to avoid that the overall sealing effect is affected by excessively large or small width, and to assist the fixing component to perform complete fixing and sealing. Compared with the prior art, different rows of soft sealing films can be mounted for sealing the plates, which effectively solves the problem that the plate sealing film needs to be matched with the PCR plates with different wells according to different use requirements, so the plate sealing films with different sizes will be used for sealing the tops of the PCR plates. When the mounting component is used, the second knob is controlled first; the threaded sleeve ring is mounted on the rod body of the threaded transmission rod in a threaded manner; and the component mounting rod is fixedly mounted between the threaded sleeve ring and the limiting slider, so that the distance of the C-shaped steering bar can be adjusted. In addition, the T-shaped limiting plate is mounted at the inner upper end of the movable inserting slot through the plurality of limiting springs, so that the plurality of positioning rods arranged on the lower surface of the pressing transverse plate can be matched with the lateral positioning holes.

### BRIEF DESCRIPTION OF DRAWINGS

FIG. 1 is a schematic diagram of an overall structure of a PCR plate sealing film with good sealing effect according to the present disclosure:

FIG. 2 is a schematic diagram of a bottom-view structure of the PCR plate sealing film with good sealing effect according to the present disclosure:

FIG. 3 is a schematic diagram of a partial structure of the PCR plate sealing film with good sealing effect according to the present disclosure:

FIG. 4 is a schematic diagram of another partial structure of the PCR plate sealing film with good sealing effect according to the present disclosure:

FIG. 5 is a schematic diagram of another partial bottom-view structure of the PCR plate sealing film with good sealing effect according to the present disclosure:

FIG. 6 is a schematic diagram of a structure of a fixing component of the PCR plate sealing film with good sealing effect according to the present disclosure:

FIG. 7 is a schematic diagram of a side-view structure of the fixing component of the PCR plate sealing film with good sealing effect according to the present disclosure:

FIG. 8 is a schematic diagram of a sectional structure at A-A in FIG. 7 of the PCR plate sealing film with good sealing effect according to the present disclosure:

FIG. 9 is a schematic diagram of a sectional structure at B-B in FIG. 7 of the PCR plate sealing film with good sealing effect according to the present disclosure:

FIG. 10 is a schematic diagram of a structure of a mounting component of the PCR plate sealing film with good sealing effect according to the present disclosure:

FIG. 11 is a schematic diagram of a front-view structure of the mounting component of the PCR plate sealing film with good sealing effect according to the present disclosure:

FIG. 12 is a schematic diagram of a sectional structure at C-C in FIG. 10 of the PCR plate sealing film with good sealing effect according to the present disclosure:

FIG. 13 is a schematic diagram of a sectional structure at D-D in FIG. 10 of the PCR plate sealing film with good sealing effect according to the present disclosure:

FIG. 14 is a schematic diagram of a structure of a matching bolt of the PCR plate sealing film with good sealing effect according to the present disclosure; and

FIG. 15 is a schematic diagram of a structure of a transmission gear of the PCR plate sealing film with good sealing effect according to the present disclosure.

In the figures; 1. supporting main plate; 2. soft sealing film; 3. fixing component; 301. first knob; 302. first expansion slot; 303. second expansion slot; 304. first expansion rod; 305. second expansion rod; 3051. fine-adjustment spring; 3052. limit mounting disk; 306. matching teeth; 307. rotating arc slot; 308. matching bolt; 3081. transmission bulge; 3082. matching thread; 309. transmission gear; 3091. matching through hole; 310. rotating threaded slot; 4. mounting component; 401. C-shaped steering bar; 402. soft film lateral-position clamping slot; 403. second knob; 404. pressing transverse plate; 405. turn-over mounting sleeve; 406. component mounting rod; 407. threaded transmission rod; 408. limiting spring; 409. movable inserting slot; 410. T-shaped limiting plate; 411. positioning rod; 412. lateral-position guiding slot; 413. threaded sleeve ring; 414. limiting slider; 5. L-shaped expansion rod; 6. lateral-position limiting bar; 7. PCR plate clamping slot; 8. soft film mounting bar; 9. sealing bulge; 10. component turning slot; 11. limit penetrating rod; 12. soft sleeve mounting slot; 13. butt positioning slot; 14. butt positioning bar; 15. lateral positioning hole and 16. insertion mounting soft sleeve.

### DETAILED DESCRIPTION

Technical solutions in embodiments of the present disclosure are clearly and completely described with reference to the embodiments of the present disclosure. Apparently, the embodiments described below are merely part, not all, of the embodiments of the present disclosure. Based on the embodiments described herein, all other embodiments obtained by those of ordinary skill in the art without creative work are within the scope of the present disclosure.

### EMBODIMENT

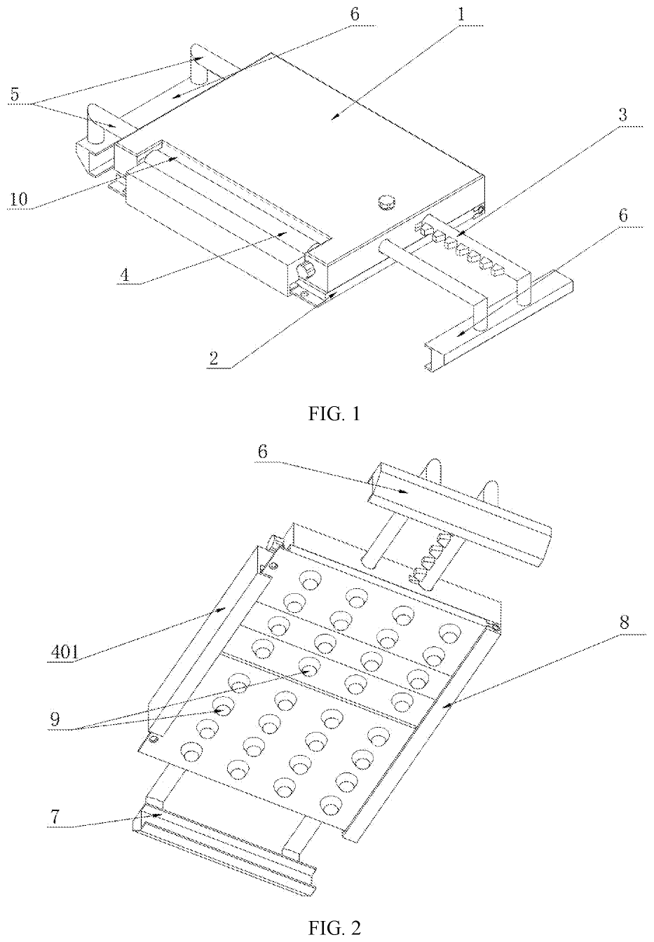

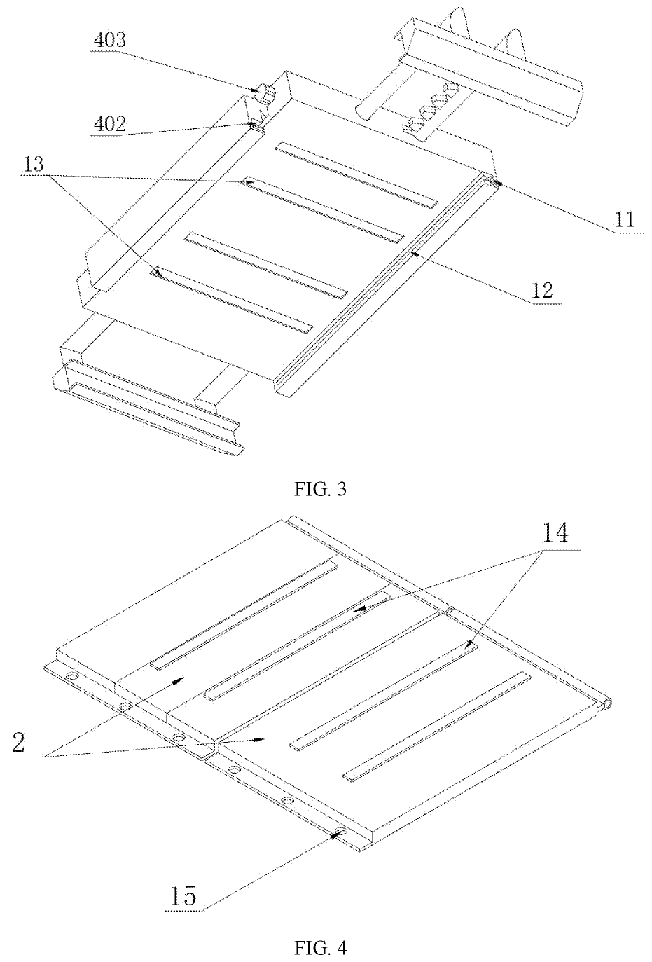

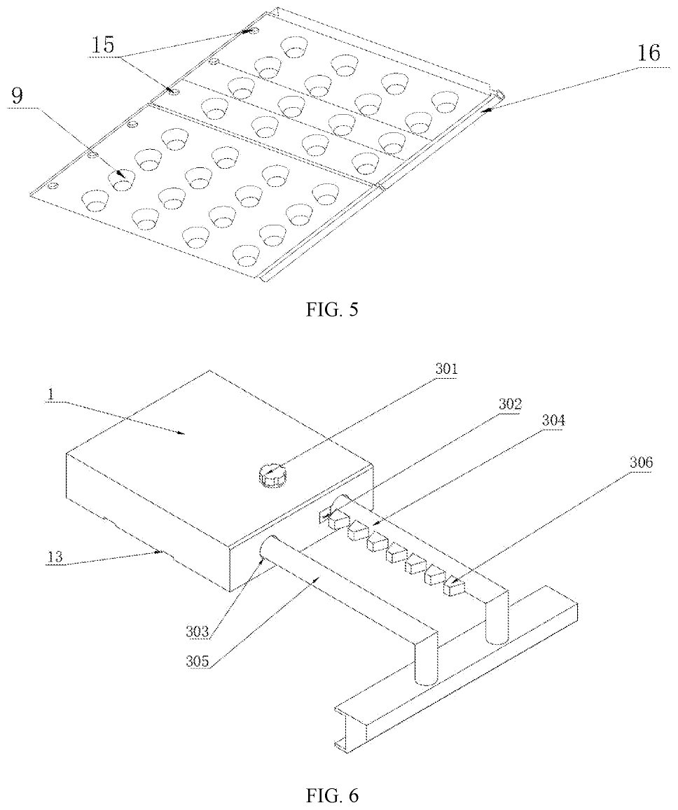

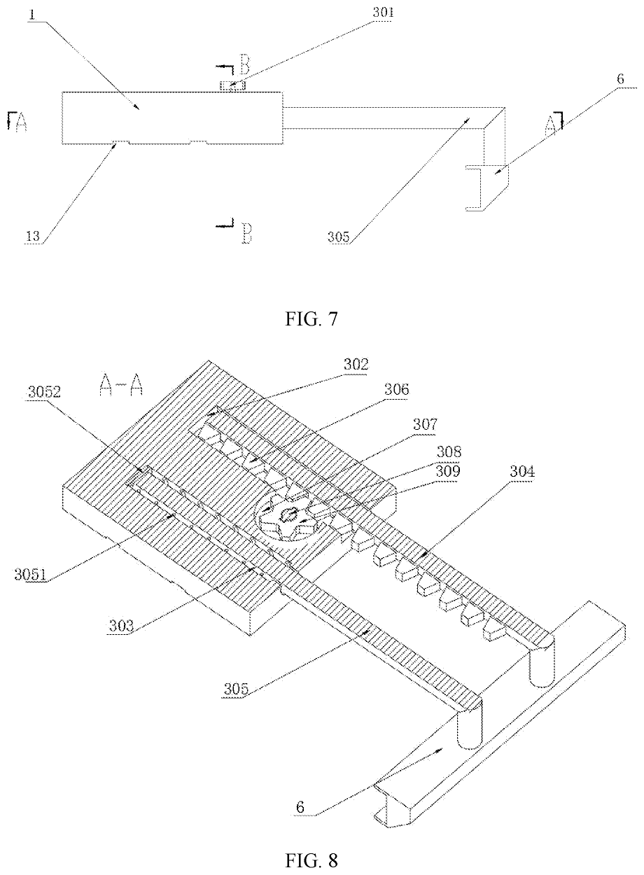

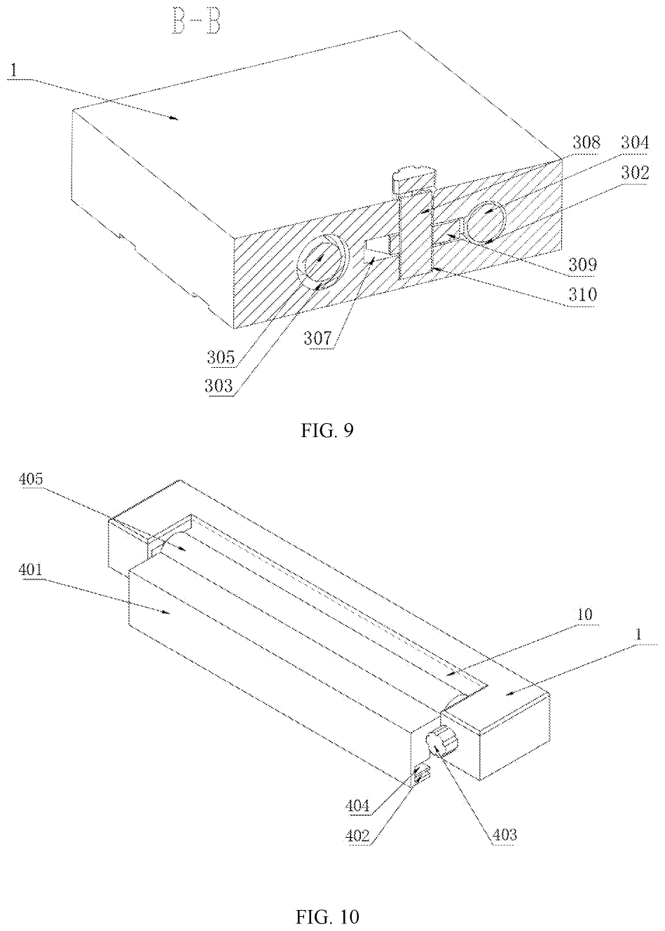

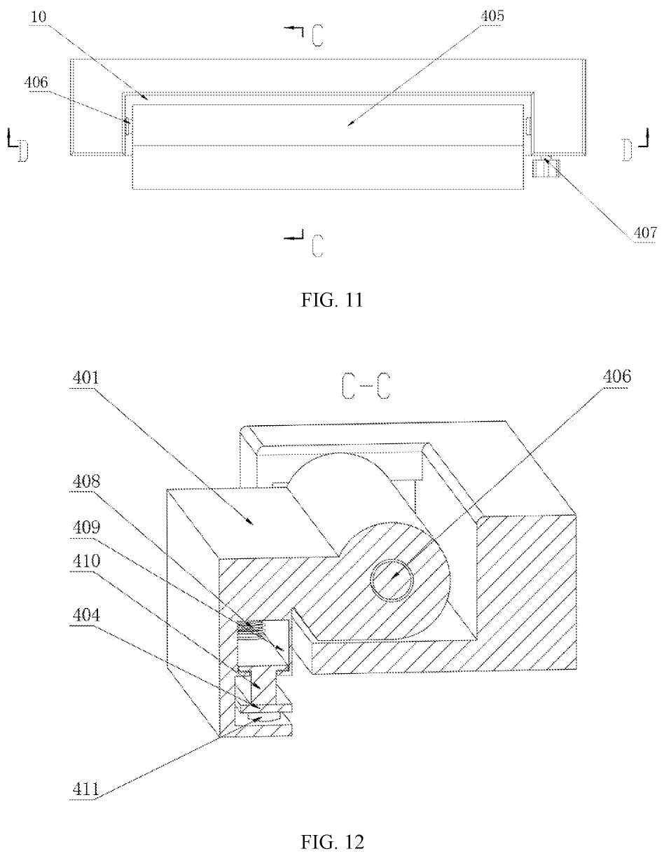

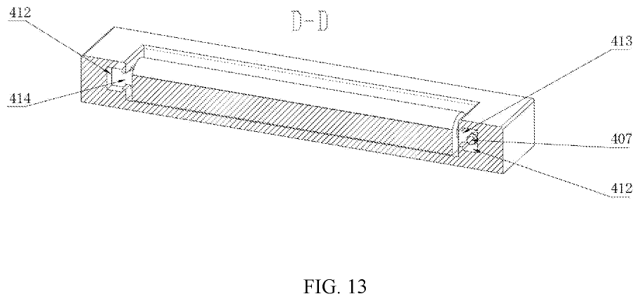

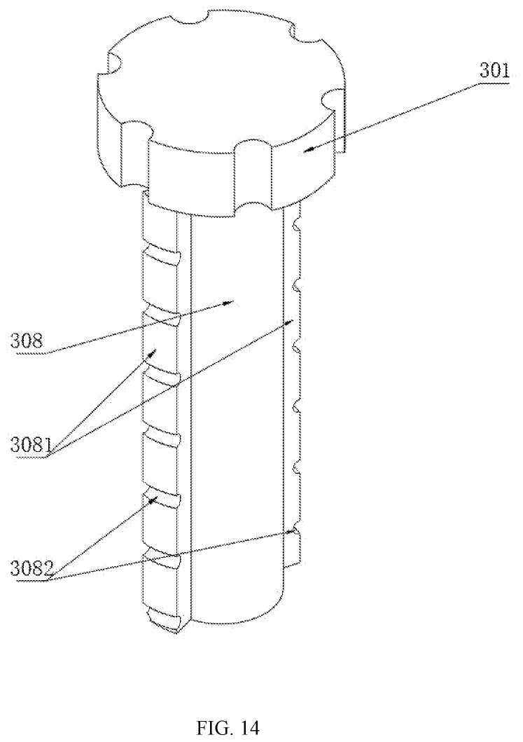

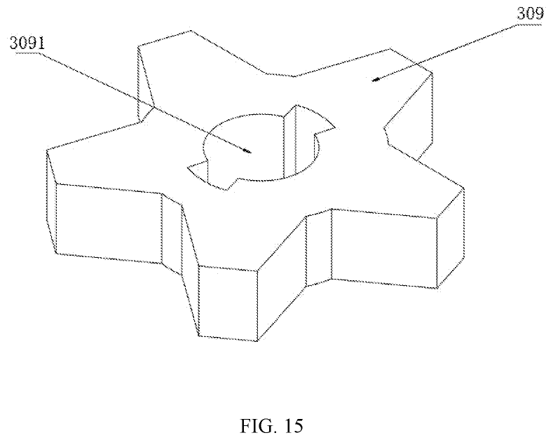

As shown in FIGS. 1-15, a PCR plate sealing film with good sealing effect comprises a supporting main plate 1 and soft sealing films 2; L-shaped expansion rods 5 are fixedly mounted on one end surface of the supporting main plate 1 respectively; lateral-position limiting bars 6 are fixedly mounted at lower ends of the two L-shaped expansion rods 5; a plurality of sealing bulges 9 are integrally arranged on lower surfaces of the soft sealing films 2 respectively; the soft sealing films 2 are located below the supporting main plate 1; a component turning slot 10 is formed in one side of an upper surface of the supporting main plate 1; soft film mounting bars 8 are integrally arranged on a lower surface of the supporting main plate 1 at one side away from the component turning slot 10; a soft sleeve mounting slot 12 is formed in a surface of the soft film mounting bar 8 at one side close to the component turning slot 10; a mounting component 4 is mounted inside the component turning slot 10; a lower end of the mounting component 4 passes through a soft film lateral-position clamping slot 402; a plurality of soft sealing films 2 are mounted between the lower end of the mounting component 4 and the soft sleeve mounting slot 12; a butt positioning bar 14 is arranged above each soft sealing film 2; a plurality of butt positioning slots 13 are respectively formed in a lower surface of the supporting main plate 1; each butt positioning bar 14 is clamped into the corresponding butt positioning slot 13; and a fixing component 3 is mounted inside one end of the supporting main plate 1 at one side away from the L-shaped expansion rods 5, and comprises a first expansion slot 302 and a second expansion slot 303.

By adopting the above solution, the width of the soft sealing films 2 can be controlled and adjusted by the mounting component 4, to avoid that the overall sealing effect is affected by excessively large or small width, and to assist the fixing component 3 to perform complete fixing and sealing. Compared with the prior art, different rows of soft sealing films 2 can be mounted for sealing the plates, which effectively solves the problem that the plate sealing film needs to be matched with the PCR plates with different wells according to different use requirements, so the plate sealing films with different sizes will be used for sealing the tops of the PCR plates. The PCR plate sealing film provided by the present disclosure is fixed by the fixing component 3, to prevent the soft sealing films 2 from moving up and down after being mounted. Compared with the prior art, the present disclosure solves problems that the PCR plate is still movable after the plate sealing film is used, and the plate sealing film is easy to be separated during movement, thereby making objects inside the PCR plate be in contact with the external world to further affect the later experimental effects, so the sealing performance of the present disclosure is greatly improved in comparison with the prior art.

In the present embodiment, the mounting component 4 comprises two lateral-position guiding slots 412, which are respectively formed in both sides of an inner wall of the component turning slot 10; a limiting slider 414 is mounted inside the lateral-position guiding slot 412 at one side close to the L-shaped expansion rod 5 in a limited sliding manner; a threaded transmission rod 407 is rotatably mounted inside the lateral-position guiding slot 412 at one side close to the fixing component 3; a second knob 403 is fixedly mounted at the end of the threaded transmission rod 407 penetrating through the component turning slot 10; a threaded sleeve ring 413 is mounted on a rod body of the threaded transmission rod 407 in a threaded manner; the threaded sleeve ring 413 is arranged inside the lateral-position guiding slot 412 at one side close to the L-shaped expansion rod 5 in a limited manner; a component mounting rod 406 is fixedly mounted between the threaded sleeve ring 413 and the limiting slider 414; and a C-shaped steering bar 401 is rotatably mounted on the rod body of the component mounting rod 406 through a turn-over mounting sleeve 405. The second knob 403 is controlled; then, the threaded sleeve ring 413 is mounted on the rod body of the threaded transmission rod 407 in a threaded manner; and the component mounting rod 406 is fixedly mounted between the threaded sleeve ring 413 and the limiting slider 414, so that the distance of the C-shaped steering bar 401 can be adjusted. In addition, the T-shaped limiting plate 410 is mounted at the inner upper end of the movable inserting slot 409 through the plurality of limiting springs 408, so that the plurality of positioning rods 411 arranged on the lower surface of the pressing transverse plate 404 can be matched with the lateral positioning holes 15.

It should be noted that a soft film lateral-position clamping slot 402 is formed in a lower end surface of the C-shaped steering bar 401 at one side away from the soft film mounting bar 8; a movable inserting slot 409 is formed in an inner upper end of the soft film lateral-position clamping slot 402; a T-shaped limiting plate 410 is mounted at the inner upper end of the movable inserting slot 409 through a plurality of limiting springs 408, and is movably arranged in the movable inserting slot 409; a pressing transverse plate 404 is integrally arranged on the lower end surface of the T-shaped limiting plate 410; and a plurality of positioning rods 411 are arranged on the lower surface of the pressing transverse plate 404.

In the specific mounting process, the first expansion slot 302 and the second expansion slot 303 are respectively formed in the surface of the supporting main plate 1 at one side away from the L-shaped expansion rod 5; a second expansion rod 305 is inserted inside the second expansion slot 303; a limit mounting disk 3052 is integrally arranged at the end of the rod body of the second expansion rod 305 located at one side in the second expansion slot 303; a fine-adjustment spring 3051 is fixedly mounted between the limit mounting disk 3052 and an inner wall of one side of the second expansion slot 303; a first expansion rod 304 is inserted inside the second expansion slot 303; a plurality of matching teeth 306 are integrally arranged at one side of the rod body of the first expansion rod 304 respectively; and the lateral-position limiting bars 6 are fixedly mounted at lower ends of one sides of the first expansion rod 304 and the second expansion rod 305.

It is understandable that a rotating arc slot 307 is formed inside the supporting main plate 1 located at one side between the plurality of matching teeth 306 and the second expansion slot 303; a transmission gear 309 is rotatably mounted inside the rotating arc slot 307 in a limited manner; a rotating threaded slot 310 is formed in the supporting main plate 1 located at one side of the middle of the rotating arc slot 307; the rotating threaded slot 310 is communicated with the rotating arc slot 307; a matching bolt 308 is mounted inside the rotating threaded slot 310 in a threaded rotating manner; a first knob 301 is fixedly mounted on the upper surface of the matching bolt 308; the rotating arc slot 307 is communicated with one side of the first expansion slot 302; and the transmission gear 309 and the corresponding matching teeth 306 are subjected to meshed transmission.

A matching through hole 3091 is formed in a center of the transmission gear 309; transmission bulges 3081 are integrally arranged at both sides of the rod body of the matching bolts 308 respectively; the transmission bulges 3081 are matched with the matching through hole 3091 in a limited manner; matching threads 3082 are formed on the outer surface of each transmission bulge 3081; and each transmission bulge 3081 is matched with the inner wall of the rotating threaded slot 310 through the matching threads 3082 in a threaded manner. The first knob 301 is rotated, so that the matching bolt 308 rotates inside the rotating arc slot 307; the matching bolt 308 is matched with the rotating arc slot 307 to effectively avoid moving again after adjustment; the transmission bulges 3081 are arranged on the matching bolt 308 and are matched with the matching through holes 3091, so that the transmission gear 309 can rotate accordingly; the matching threads 3082 are provided to ensure the normal matching of the matching bolt 308; the first expansion rod 304 can be adjusted in position by utilizing the rotation of the transmission gear 309 and the meshing with the matching teeth 306; the second expansion rod 305 is driven to move accordingly by the lateral-position limiting bars 6; and the first expansion rod 305 is matched with the second expansion slot 303 through the fine-adjustment spring 3051, so that the fixing position can be finely adjusted by the second expansion rod 305, thereby avoiding the problem that the fixing position is not fixed completely at certain small angles. In the present embodiment, a plurality of lateral positioning holes 15 are respectively formed in one side of each soft sealing film 2 at one side close to the mounting component 4 in a penetrating manner; an insertion mounting soft sleeve 16 is integrally arranged on one side of each soft sealing film 2 at one side close to the soft sleeve mounting slot 12 respectively; a limit penetrating rod 11 is integrally arranged inside the soft sleeve mounting slot 12; the outer periphery of the limit penetrating rod 11 is matched with each insertion mounting soft sleeve 16 in an inserting manner; a PCR plate clamping slot 7 is formed in an opposite surface of each lateral-position limiting bar 6; and each lateral positioning hole 15 is matched with the corresponding positioning rod 411 in an inserting manner.

The PCR plate sealing film with good sealing effect has the operating principles that

When the PCR plate sealing film is used, different numbers of soft sealing films 2 should be arranged as required; the expanded and added sizes are different, so different styles can be customized to correspond to different types of PCR plates; in the arrangement process, the plurality of lateral positioning holes 15 are respectively formed in one side of each soft sealing film 2 and are matched with the corresponding positioning rods 411 in a penetrating manner; the insertion mounting soft sleeve 16 is integrally arranged on the other side of each soft sealing film 2; the outer periphery of the limit penetrating rod 11 is matched with each insertion mounting soft sleeve 16 in a penetrating manner, thereby arranging the plurality of soft sealing films 2; in order to avoid moving after arrangement, each butt positioning bar 14 is clamped into the corresponding butt positioning slot 13, thereby effectively reducing the problem of translational movement; after the assembling process is completed, the lateral-position limiting bar 6 located at one side of the L-shaped expansion rod 5 is matched with one side of the corresponding PCR plate in a clamping manner through the PCR plate clamping slot 7; and then, the plurality of sealing bulges 9 are inserted in the PCR plate clamping slots in a sealing manner.

After that, the PCR plate sealing film should be fixed by the fixing component 3, to prevent the soft sealing films 2 from moving up and down after being mounted. Compared with the prior art, the present disclosure solves problems that the PCR plate is still movable after the plate sealing film is used, and the plate sealing film is easy to be separated during movement, thereby making the objects inside the PCR plate be in contact with the external world to further affect the later experimental effects, so the sealing performance of the present disclosure is greatly improved in comparison with the prior art. When the fixing component 3 is used, the first knob 301 is rotated first, so that the matching bolt 308 rotates inside the rotating arc slot 307; the matching bolt 308 is matched with the rotating arc slot 307 to effectively avoid moving again after adjustment; the transmission bulges 3081 are arranged on the matching bolt 308 and are matched with the matching through holes 3091, so that the transmission gear 309 can rotate accordingly; the matching threads 3082 are provided to ensure the normal matching of the matching bolt 308; the first expansion rod 304 can be adjusted in position by utilizing the rotation of the transmission gear 309 and the meshing with the matching teeth 306; the second expansion rod 305 is driven to move accordingly by the lateral-position limiting bars 6; and the first expansion rod 305 is matched with the second expansion slot 303 through the fine-adjustment spring 3051, so that the fixing position can be finely adjusted by the second expansion rod 305, thereby avoiding the problem that the fixing position is not fixed completely at certain small angles.

When the soft sealing films 2 with different sizes need to be mounted, the mounting component 4 is needed; and the width of the soft sealing films 2 can be controlled and adjusted by the mounting component 4, to avoid that the overall sealing effect is affected by excessively large or small width, and to assist the fixing component 3 to perform complete fixing and sealing. Compared with the prior art, different rows of soft sealing films 2 can be mounted for sealing the plates, which effectively solves the problem that the plate sealing film needs to be matched with the PCR plates with different wells according to different use requirements, so the plate sealing films with different sizes will be used for sealing the tops of the PCR plates. When the mounting component 4 is used, the second knob 403 is controlled first; the threaded sleeve ring 413 is mounted on the rod body of the threaded transmission rod 407 in a threaded manner; and the component mounting rod 406 is fixedly mounted between the threaded sleeve ring 413 and the limiting slider 414, so that the distance of the C-shaped steering bar 401 can be adjusted. In addition, the T-shaped limiting plate 410 is mounted at the inner upper end of the movable inserting slot 409 through the plurality of limiting springs 408, so that the plurality of positioning rods 411 arranged on the lower surface of the pressing transverse plate 404 can be matched with the lateral positioning holes 15.

The basic principle, main features, and advantages of the present disclosure are shown and described above. Those skilled in the art should know that the present disclosure is not limited by the above embodiments. The above embodiments and description only describe the principles of the present disclosure. Without departing from the spirit and scope of the present disclosure, various changes and improvements will also be made to the present disclosure, and fall within the requested scope of the present disclosure. The scope of protection requested by the present disclosure is defined by the attached claim and its equivalents.

1. A PCR plate sealing film with good sealing effect, comprising a supporting main plate (1) and soft sealing films (2), wherein L-shaped expansion rods (5) are fixedly mounted on one end surface of the supporting main plate (1) respectively; lateral-position limiting bars (6) are fixedly mounted at lower ends of the two L-shaped expansion rods (5); a plurality of sealing bulges (9) are integrally arranged on lower surfaces of the soft sealing films (2) respectively; the soft sealing films (2) are located below the supporting main plate (1); a component turning slot (10) is formed in one side of an upper surface of the supporting main plate (1); soft film mounting bars (8) are integrally arranged on a lower surface of the supporting main plate (1) at one side away from the component turning slot (10); a soft sleeve mounting slot (12) is formed in a surface of the soft film mounting bar (8) at one side close to the component turning slot (10); a mounting component (4) is mounted inside the component turning slot (10); a lower end of the mounting component (4) passes through a soft film lateral-position clamping slot (402); a plurality of soft sealing films (2) are mounted between the lower end of the mounting component (4) and the soft sleeve mounting slot (12); a butt positioning bar (14) is arranged above each soft sealing film (2); a plurality of butt positioning slots (13) are respectively formed in a lower surface of the supporting main plate (1); each butt positioning bar (14) is clamped into the corresponding butt positioning slot (13); and a fixing component (3) is mounted inside one end of the supporting main plate (1) at one side away from the L-shaped expansion rods (5), and comprises a first expansion slot (302) and a second expansion slot (303).

2. The PCR plate sealing film with good sealing effect according to claim 1, wherein the mounting component (4) comprises two lateral-position guiding slots (412), which are respectively formed in both sides of an inner wall of the component turning slot (10); and a limiting slider (414) is mounted inside the lateral-position guiding slot (412) at one side close to the L-shaped expansion rod (5) in a limited sliding manner.

3. The PCR plate sealing film with good sealing effect according to claim 2, wherein a threaded transmission rod (407) is rotatably mounted inside the lateral-position guiding slot (412) at one side close to the fixing component (3); a second knob (403) is fixedly mounted at the end of the threaded transmission rod (407) penetrating through the component turning slot (10); and a threaded sleeve ring (413) is mounted on a rod body of the threaded transmission rod (407) in a threaded manner.

4. The PCR plate sealing film with good sealing effect according to claim 3, wherein the threaded sleeve ring (413) is arranged inside the lateral-position guiding slot (412) at one side close to the L-shaped expansion rod (5) in a limited manner; a component mounting rod (406) is fixedly mounted between the threaded sleeve ring (413) and the limiting slider (414); and a C-shaped steering bar (401) is rotatably mounted on the rod body of the component mounting rod (406) through a turn-over mounting sleeve (405).

5. The PCR plate sealing film with good sealing effect according to claim 4, wherein a soft film lateral-position clamping slot (402) is formed in a lower end surface of the C-shaped steering bar (401) at one side away from the soft film mounting bar (8); a movable inserting slot (409) is formed in an inner upper end of the soft film lateral-position clamping slot (402); a T-shaped limiting plate (410) is mounted at the inner upper end of the movable inserting slot (409) through a plurality of limiting springs (408), and is movably arranged in the movable inserting slot (409); a pressing transverse plate (404) is integrally arranged on the lower end surface of the T-shaped limiting plate (410); and a plurality of positioning rods (411) are arranged on the lower surface of the pressing transverse plate (404).

6. The PCR plate sealing film with good sealing effect according to claim 1, wherein the first expansion slot (302) and the second expansion slot (303) are respectively formed in the surface of the supporting main plate (1) at one side away from the L-shaped expansion rod (5); a second expansion rod (305) is inserted inside the second expansion slot (303); a limit mounting disk (3052) is integrally arranged at the end of the rod body of the second expansion rod (305) located at one side in the second expansion slot (303); a fine-adjustment spring (3051) is fixedly mounted between the limit mounting disk (3052) and an inner wall of one side of the second expansion slot (303); a first expansion rod (304) is inserted inside the second expansion slot (303); a plurality of matching teeth (306) are integrally arranged at one side of the rod body of the first expansion rod (304) respectively; and the lateral-position limiting bars (6) are fixedly mounted at lower ends of one sides of the first expansion rod (304) and the second expansion rod (305).

7. The PCR plate sealing film with good sealing effect according to claim 6, wherein a rotating arc slot (307) is formed inside the supporting main plate (1) located at one side between the plurality of matching teeth (306) and the second expansion slot (303); a transmission gear (309) is rotatably mounted inside the rotating arc slot (307) in a limited manner; and a rotating threaded slot (310) is formed in the supporting main plate (1) located at one side of the middle of the rotating arc slot (307).

8. The PCR plate sealing film with good sealing effect according to claim 7, wherein the rotating threaded slot (310) is communicated with the rotating arc slot (307); a matching bolt (308) is mounted inside the rotating threaded slot (310) in a threaded rotating manner; a first knob (301) is fixedly mounted on the upper surface of the matching bolt (308); the rotating arc slot (307) is communicated with one side of the first expansion slot (302); and the transmission gear (309) and the corresponding matching teeth (306) are subjected to meshed transmission.

9. The PCR plate sealing film with good sealing effect according to claim 8, wherein a matching through hole (3091) is formed in a center of the transmission gear (309); transmission bulges (3081) are integrally arranged at both sides of the rod body of the matching bolts (308) respectively; the transmission bulges (3081) are matched with the matching through hole (3091) in a limited manner; matching threads (3082) are formed on the outer surface of each transmission bulge (3081); and each transmission bulge (3081) is matched with the inner wall of the rotating threaded slot (310) through the matching threads (3082) in a threaded manner.

10. The PCR plate sealing film with good sealing effect according to claim 1, wherein a plurality of lateral positioning holes (15) are respectively formed in one side of each soft sealing film (2) at one side close to the mounting component (4) in a penetrating manner; an insertion mounting soft sleeve (16) is integrally arranged on one side of each soft sealing film (2) at one side close to the soft sleeve mounting slot (12) respectively; a limit penetrating rod (11) is integrally arranged inside the soft sleeve mounting slot (12); the outer periphery of the limit penetrating rod (11) is matched with each insertion mounting soft sleeve (16) in an inserting manner; a PCR plate clamping slot (7) is formed in an opposite surface of each lateral-position limiting bar (6); and each lateral positioning hole (15) is matched with the corresponding positioning rod (411) in an inserting manner.
